(19) United States
(12) Patent Application Publication
(10) Pub. No.: US 2010/0181378 A1
(43) Pub. Date: Jul. 22, 2010

(54) BEVERAGE MAKER WITH COMPACT OPTICAL CODE READER

(75) Inventors: Hiroshi Hayakawa, Saitama (JP); Naoki Yoshihara, Kanagawa (JP); Naoya Niizeki, Saitama (JP); Yo Tanaka, Tokyo (JP); Kazunori Noborio, Tokyo (JP)

Correspondence Address: Kaplan Gilman & Pergament LLP, 1480 Route 9 North, Woodbridge, NJ, 07095, US

(73) Assignees: Optoelectronics Co., Ltd., Saitama Pref. (JP); Opticon, Inc., Orangeburg, NY (US)

(21) Appl. No.: 12/530,278

(22) PCT Filed: Mar. 9, 2007
(86) PCT No.: PCT/US07/63696

§ 371 Date: Apr. 12, 2010

(51) Int. Cl. G06K 7/10

(52) U.S. Cl. 235/454; 235/462.32

(57) ABSTRACT

A compact barcode reader is provided in which the imaging lens and a linear sensor are in a straight line path with the barcode (no bend in path). By using a wide angle lens with a short back focus, it is possible to reduce the distance between the barcode and linear sensor to a fraction of what it was in the prior art. In addition, the maximum image height and the downward projection of the sensor are reduced to a fraction of what they were in the prior art. As a result, despite the straight line optical path, compact barcode reader becomes so small that it does not interfere with the operation of the beverage maker.

### BACKGROUND OF THE INVENTION

The present invention relates generally to beverage makers and, more particularly, concerns a beverage maker including a compact integral optical code reader, such as a barcode reader, to be used with ingredient packages containing optical codes, such as for preparation of a beverage.

FIG. 1 is a schematic representation of a typical beverage preparation machine of the type which prepares and dispenses coffee and tea. The machine M includes a water supply tank T, which is filled with water, and a water pump P pumps water from the tank T into a heater H. The actual beverage is made by pumping the hot water through a cartridge C which contains a powder, or the like, to form the beverage. An optical code, such as a barcode, B is provided on a lower surface of the cartridge C and is read by a barcode reader R when the cartridge is placed into the machine. The barcode may, for example, provide a description of the beverage to be made and instructions for controlling its preparation.

As is typical, the barcode reader R includes a linear sensor L and a lens N which focuses the barcode on the sensor L. Typically, the lens N has a focal length greater than 25 mm and the sensor L must be placed at a distance of approximately 100 mm from the barcode. Owing to the significant length of the barcode reader R, it is placed in a crosswise orientation general parallel to the barcode B, and a mirror I is provided to bend the light path so that the barcode may be read at the side of the reader R and reflected lengthwise along the reader. If the barcode reader R did not have the mirror I, it would be positioned vertically and would interfere with the placement of a cup to receive the beverage within the apparatus. Nevertheless, even with its illustrated placement, the barcode reader R is large and cumbersome and, because it projects into the open, can possibly be damaged during use of the machine.

It would therefore be desirable to have a barcode reader which can be kept within the confines of the vicinity of the cartridge, without projecting substantially beyond that vicinity.

### SUMMARY OF THE INVENTION

In accordance with the present invention, a compact barcode reader is provided in which the imaging lens and, preferably, the linear sensor are in a straight line path with the barcode (no bend in path). By using a wide angle lens with a short back focus, it is possible to reduce the distance between the barcode and linear sensor to a fraction of what it was in the prior art. In addition, the maximum image height and the downward projection of the sensor are reduced to a fraction of what they were in the prior art. As a result, despite the straight line optical path, compact barcode reader becomes so small that it does not interfere with the operation of the beverage maker.

### BRIEF DESCRIPTION OF THE DRAWINGS

The foregoing brief description and further objects, features and advantages of the present invention will be understood more completely from the following detailed descriptions of presently preferred, but nonetheless illustrative, embodiments of the invention, which reference being had to the accompanying drawings, in which:

FIG. 1 is a schematic representation of a typical beverage preparation machine of the type which prepares and dispenses coffee and tea, the machine including a bar code reader;

FIG. 2 is a schematic representation of the beverage machine of FIG. 1 after a compact barcode reader embodying the present invention has been substituted for the original barcode reader;

FIG. 3 is an enlarged schematic view of a conventional barcode reader R as seen in FIG. 1;

FIG. 4 is a schematic representation of the optical system of a compact barcode reader 10 embodying the present invention;

FIGS. 5A and 5B (also referred to herein collectively as FIG. 5) are a schematic plan view and side view, respectively, of a first embodiment 10 of a compact barcode scanner embodying the present invention; and

FIGS. 6A and 6B are a plan view and side view, respectively, of a second embodiment of a compact barcode scanner in with the present invention.

### DETAILED DESCRIPTION OF THE PREFERRED EMBODIMENTS

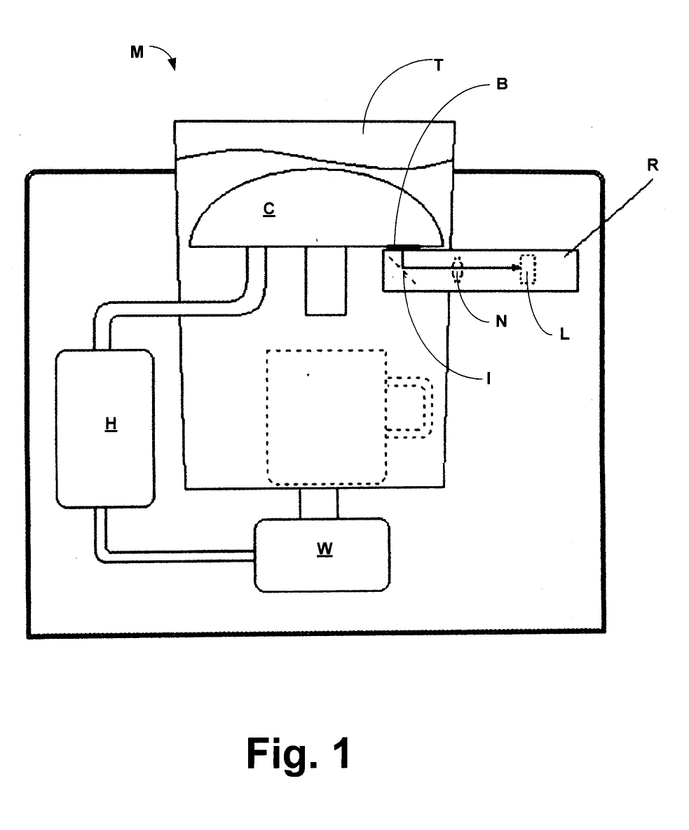

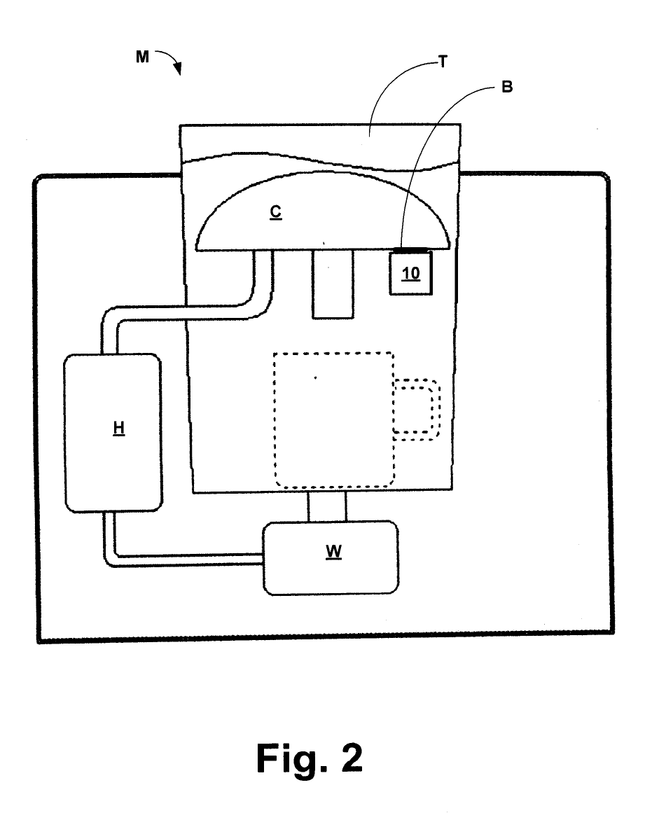

FIG. 2 is a schematic representation of the beverage machine of FIG. 1 after a compact barcode reader 10, embodying the present invention, has been substituted for the barcode reader R. All elements which are identified by the same reference characters as in FIG. 1 are identical. It should be noted that reader 10 is well out of the user's way and is in a protected position, confined within the footprint projected by cartridge C.

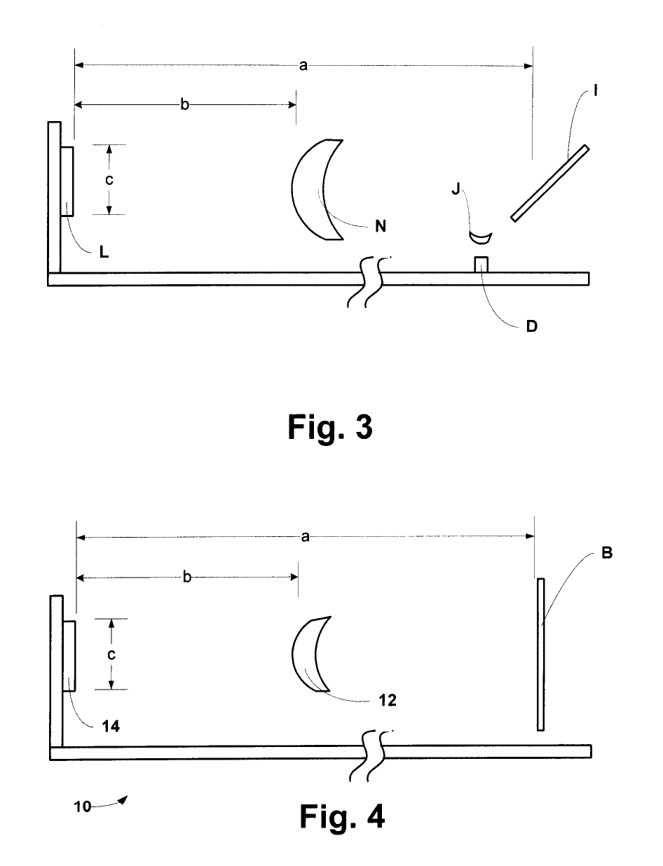

FIG. 3 is an enlarged schematic view of a conventional barcode reader R as seen in FIG. 1. It will be understood that the barcode is above the mirror I as shown in FIG. 1. In addition to the elements already discussed, barcode reader R includes an LED D and a projection lens J, which illuminate the barcode. The physical characteristics of a barcode reader in accordance with the prior art and of compact barcode reader embodying the present invention are summarized in Table 1 below.

TABLE 1

| | Prior | Compact | | |
|---|---|---|---|---|
| | Art | Barcode Reader | X | Y |
| Focal length (mm) | 26.83 | 6.314 | 8.34 | 12.8 |
| Angle of field | 30 | 66 | 42 | 66 |
| (degree) | | | | |
| Back focus (mm) | 42 | 7.6 | 10.8 | 25.3 |
| Distance between | 102 | 32 | 50 | 50 |
| object and image | | | | |
| (mm) | | | | |
| Maximum image | 14.3 | 4.0 | 4.0 | 14.3 |
| height (mm) | | | | |
| Width of sensor | 28.6 | 8.0 | 8 | 28.6 |
| (mm) | | | | |

In one conventional barcode reader, the focal length of the imaging lens N is 26.83 mm and it has an angle of field of 30°, which is typical. The back focus b, the distance between the lens N and the linear sensor L, is 42 mm, and the overall distance a between the barcode and the sensor L (represented in the drawing as only the distance to the mirror) must be maintained at 102 mm. For that reason, it is necessary to provide the mirror I so that the barcode reader R could project laterally (in FIG. 1) instead of downward, into the portion of the beverage maker used by the operator. With the optical system of the prior art, the maximum height of the image of the bar code was 14.3 mm and the height dimension c of the sensor L was 28.6 mm.

Reference is made in Table 1 to the angle of field of a lens. This will be understood to be the angle of view, which is related to a linear dimension of the image on the sensor and the focal length of the lens. In the present context, that would be the angle of view at the image sensor in the direction of image height, which is also referred to herein as the “width” of the sensor. Lenses may be referred to herein as “wide angle” or “normal.” A normal lens will be understood to have an angle of view of approximately 30°. A lens with an angle of view substantially above that will be considered a “wide angle” lens, and a lens with an angle of view substantially below that will be considered a “telephoto.” Referring to Table 1, it will be seen that the prior art barcode readers for beverage makers contained normal lenses.

FIG. 4 is a schematic representation of the optical system of a compact barcode reader 10 embodying the present invention. Use is made of a wide angle lens 12 which, in the preferred embodiment, has a focal length of 6.31 mm and a field of view of 66°. The back focus b between lens 12 and image sensor 14 is only 7.6 mm, and the wider optical field of the lens 12 permits it to be placed closer to the barcode B, resulting in a total distance a between barcode B and the image sensor 14 of only 32 mm. This permits the maintenance of a straight line path between the barcode B, and the lens 12, without significant projection of compact barcode reader 10 into the operator's area of the beverage maker (represented by a phantom image of a cup). In addition, the maximum image height produced by the lens 14 is only 4.0 mm, permitting the use of a sensor 14 with a lateral dimension c of only 8 mm.

To achieve sufficient compactness of the scanner 10, it is preferred that the total distance a between barcode B and the image sensor 14 in FIG. 4 be no greater than approximately 50 mm. The two right hand columns of Table 1 illustrate the dimensions for two alternate embodiments X and Y which achieve a sufficiently compact construction with a total distance a, which is less than approximately 50 mm. Embodiment X utilizes a lens with an 8.34 mm focal length and a 42° angle of field. It can then make use of the same sensor and maximum image size as the first embodiment. The smaller angle of field makes the lens easier to design and manufacture.

In alternate embodiment Y, the focal length of the lens is increased to 12.8 and an image and sensor size which are the same as the prior art are used. With the wide angle lens, it is still possible to maintain dimension a no greater than approximately 50 mm.

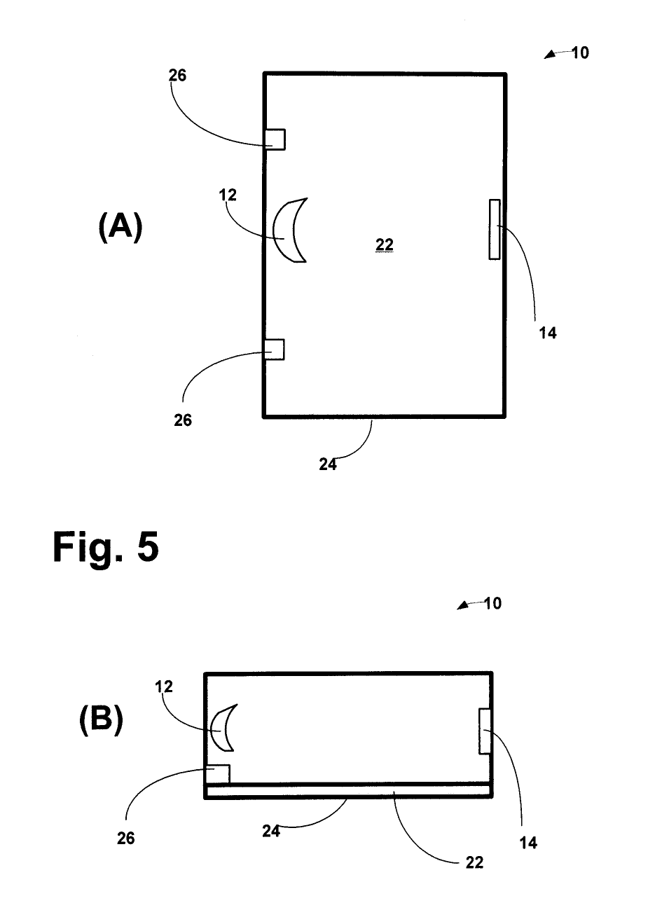

FIGS. 5A and 5B (also referred to herein collectively as FIG. 5) are a schematic plan view and side view, respectively, of a first embodiment 10 of a compact barcode scanner embodying the present invention. Scanner 10 includes a circuit board 22 and a case 24 which supports the lens 12 and the image sensor 14. Also, two LEDs 26, 26 are mounted on the circuit board 22 so as to project light to the left (in FIG. 5), to illuminate the barcode.

Circuit board 22 contains a drive circuit for the sensor 14, a signal processing circuit, a barcode pattern allows the circuit, an LED drive circuit and a control circuit. For purposes of processing, and it is assumed that the circuit board contains an ASIC with a built-in CPU. The control circuit of the beverage machine may also be built into the ASIC.

The case 24 is preferably about 13 mm long (left-right dimension in FIG. 5), about 20 mm wide (the height dimension in FIG. 5A) and about 8 mm high (the height dimension in FIG. 5B). It may be made of any convenient material, such as plastic. It has a provision for retaining the lens 12 and sensor 14 in a required, fixed relationship. Lens 12 is preferably made of plastic, and sensor 14 is preferably a CCD or CMOS image sensor.

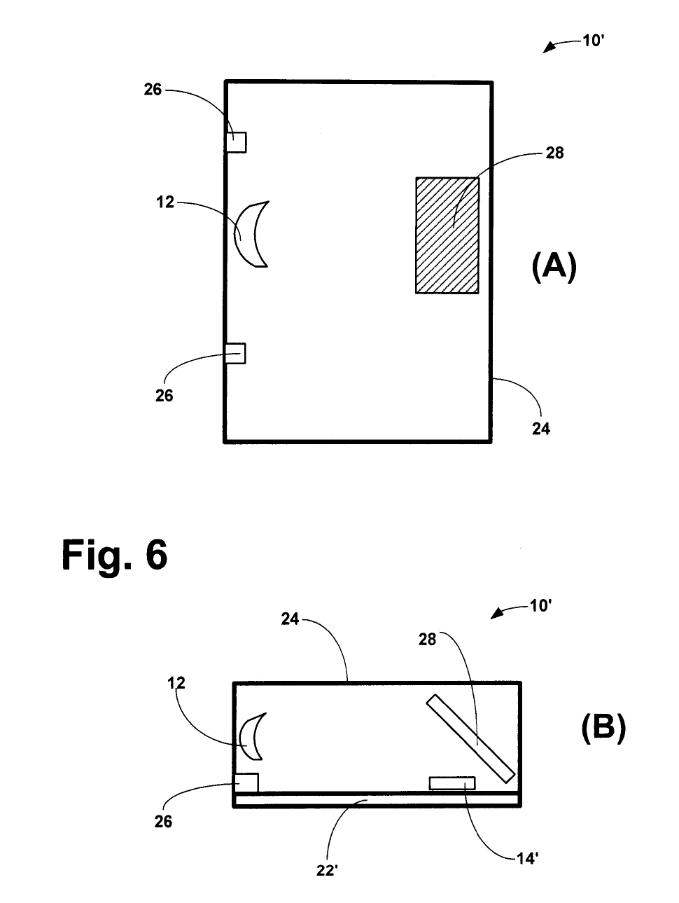

FIGS. 6A and 6B are a plan view and side view, respectively, of a second embodiment 20′ of a compact barcode sensor in accordance with the present invention. In FIG. 6, elements identical to those in FIG. 5 are indicated by the same reference characters. The primary difference is that the sensor 14 is mounted on the circuit board 22′, which is otherwise identical to circuit board 22 of FIG. 5. An angled mirror 28 is provided to produce a bent optical path to image sensor 14′. The dimensions of the barcode reader 20′ are essentially identical to those of barcode reader 20.

Barcode reader 20 is mounted so that the far (right hand) edge of case 24 is about 34 mm from the barcode, and barcode reader 20′ is mounted so that the far edge of case 24 is about 33 mm from the barcode.

Although preferred embodiments of the invention have been disclosed for illustrative purposes, those skilled in the art will appreciate that many additions, modifications, and substitutions are possible without departing from the scope and spirit of the invention as defined by the accompanying claims.

1. A compact scanner for an optical code for use in an appliance having limited space, the optical scanner including an optical sensor and an imaging lens in an optical path originating at the optical code and terminating at the sensor, the improvement comprising the lens being a wide angle lens and being in a straight line optical path with the code.

2. The scanner of claim 1 wherein sensor is also in a straight line path with the optical code.

3. The scanner of claim 1 further comprising a circuit board generally parallel to the optical path, the lens being mounted in an upright position on the board, the sensor being mounted on the board and having a sensing face generally parallel to the board, and a reflector at a distance from said lens in a direction opposite to the direction of the code and overlying the sensor, the reflector being inclined towards said lens so as to bend the light path towards said sensor in the vicinity thereof.

4. The scanner of claim 1 wherein the lens has an angle of view which is substantially greater than about 30°.

5. The scanner of claim 1 wherein the lens has an angle of view which is greater than about 40°.

6. The scanner of claim 5 wherein the lens has an angle of view which is approximately 65°.

7. The scanner of claim 1 wherein a crosswise dimension of the sensor is substantially less than about 29 mm.

8. The scanner of claim 7 wherein the crosswise dimension of the sensor is approximately 8 mm.

9. The scanner of claim 1 wherein the distance between the code and the sensor is substantially less than approximately 100 mm.

11. The scanner of claim 1 wherein the distance between the code and the sensor is less than approximately 50 mm.

12. The scanner of claim 11 wherein the distance between the code and the sensor is approximately 30 mm.

13. The scanner of claim 1 wherein the distance between the lens and the sensor is substantially less than approximately 40 mm.

14. The scanner of claim 13 wherein the distance between the lens and the sensor is less than approximately 25 mm.

15. The scanner of claim 14 wherein the distance between the lens and the sensor is approximately 7.5 mm.
